(19) United States
(12) Patent Application Publication
(10) Pub. No.: US 2025/0231459 A1
(43) Pub. Date: Jul. 17, 2025

(54) DISPLAY DEVICE AND LIGHT GUIDE ELEMENT

(71) Applicant: Japan Display Inc., Tokyo (JP)

(72) Inventors: Koichi IGETA, Tokyo (JP); Junji KOBASHI, Tokyo (JP); Shinichiro OKA, Tokyo (JP)

(73) Assignee: Japan Display Inc., Tokyo (JP)

(21) Appl. No.: 18/978,150

(22) Filed: Dec. 12, 2024

(30) Foreign Application Priority Data
Jan. 17, 2024 (JP) 2024-005280

(51) Int. Cl. G02F 1/295; G02B 27/01

(52) U.S. Cl. CPC G02F 1/295; G02B 27/0172; G02B 2027/0178; G02F 2201/16

(57) ABSTRACT

According to one embodiment, a display device includes a transparent substrate having a first main surface and a second main surface, a display element configured to emit display light toward the transparent substrate, an optical path adjustment element provided on the second main surface, a first optical element which overlaps the optical path adjustment element and diffracts display light which passed through the transparent substrate and the optical path adjustment element, and a second optical element which is provided on the second main surface and diffracts display light which propagated inside the transparent substrate. The optical path adjustment element is configured to adjust an optical path of display light to change an emission position of display light.

### CROSS-REFERENCE TO RELATED APPLICATIONS

This application is based upon and claims the benefit of priority from Japanese Patent Application No. 2024-005280, filed Jan. 17, 2024, the entire contents of which are incorporated herein by reference.

### FIELD

Embodiments described herein relate generally to a display device and a light guide element.

### BACKGROUND

Recently, various types of head-mounted displays using a holographic optical element (which may be hereinafter simply referred to as an HOE) which diffracts display light from a display element and a light guide member have been considered. For example, a technique which provides a holographic diffractive optical element on each surface of the light guide member is known. The HOE provided on one surface of the light guide member diffracts display light so as to be totally reflected on the light guide member. The HOE provided on the other surface of the light guide member diffracts display light which propagates inside the light guide member so as to be emitted to the outside.

In this head-mounted display, when the observation area in which an image is displayed is narrow, nonconformance easily occurs between the positions of the eyes of the user and the observation area. In this case, the visibility of images for the user is reduced.

### BRIEF DESCRIPTION OF THE DRAWINGS

FIG. 1 is a cross-sectional view showing a configuration example of a display device DSP according to an embodiment.

FIG. 2 is a diagram for explaining the definition of light guide length L.

FIG. 3 is a diagram for explaining the effect of an optical path adjustment element AD.

FIG. 4 is a diagram for explaining the effect of the optical path adjustment element AD.

FIG. 5 is a cross-sectional view showing a configuration example of the optical path adjustment element AD which can be applied to the display device DSP shown in FIG. 1.

FIG. 6 is a diagram for explaining the state of the optical path adjustment element AD.

FIG. 7 is a diagram for explaining the state of the optical path adjustment element AD.

FIG. 8 is a cross-sectional view showing another configuration example of the optical path adjustment element AD which can be applied to the display device DSP shown in FIG. 1.

FIG. 9 is a cross-sectional view showing another configuration example of the optical path adjustment element AD which can be applied to the display device DSP shown in FIG. 1.

FIG. 10 is a diagram for explaining the effect of the optical path adjustment element AD comprising a liquid crystal cell.

FIG. 11 is a cross-sectional view showing another configuration example of the display device DSP.

FIG. 12 is a cross-sectional view showing a configuration example of the optical path adjustment element AD which can be applied to the display device DSP shown in FIG. 11.

FIG. 13 is a cross-sectional view showing another configuration example of the optical path adjustment element AD which can be applied to the display device DSP shown in FIG. 11.

FIG. 14 is a diagram for explaining the effect of the optical path adjustment element AD comprising a liquid crystal cell.

FIG. 15 is a diagram for explaining the effect of the optical path adjustment element AD comprising a liquid crystal cell.

FIG. 16 is a diagram for explaining the effect of the optical path adjustment element AD comprising a liquid crystal cell.

FIG. 17 is a cross-sectional view showing a configuration example of the optical path adjustment element AD.

FIG. 18 is a diagram for explaining a relationship between the refractive index distribution of the first liquid crystal cell C1 shown in FIG. 17 and display light DL.

FIG. 19 is a diagram for explaining another relationship between the refractive index distribution of the first liquid crystal cell C1 shown in FIG. 17 and display light DL.

FIG. 20 is a cross-sectional view showing another configuration example of the optical path adjustment element AD.

FIG. 21 is a diagram for explaining a relationship between the refractive index distributions of the first liquid crystal cell C1 and second liquid crystal cell C2 shown in FIG. 20 and display light DL.

FIG. 22 is a diagram for explaining another relationship between the refractive index distributions of the first liquid crystal cell C1 and second liquid crystal cell C2 shown in FIG. 20 and display light DL.

FIG. 23 is a diagram for explaining another relationship between the refractive index distributions of the first liquid crystal cell C1 and second liquid crystal cell C2 shown in FIG. 20 and display light DL.

FIG. 24 is a diagram for explaining another relationship between the refractive index distributions of the first liquid crystal cell C1 and second liquid crystal cell C2 shown in FIG. 20 and display light DL.

FIG. 25 is a diagram for explaining an application example of the display device DSP.

### DETAILED DESCRIPTION

Embodiments described herein aim to provide a display device and a light guide element such that the reduction in the visibility of images can be prevented.

In general, according to one embodiment, a display device comprises a transparent substrate having a first main surface and a second main surface which faces the first main surface, a display element configured to emit display light toward the transparent substrate, an optical path adjustment element provided on the second main surface which faces the display element, a first optical element which overlaps the optical path adjustment element and diffracts display light which passed through the transparent substrate and the optical path adjustment element so as to be totally reflected inside the transparent substrate, and a second optical element which is provided on the second main surface and diffracts display light which propagated inside the transparent substrate so as to be emitted from the first main surface. The optical path adjustment element is configured to adjust an optical path of display light to change an emission position of display light.

According to another embodiment, a display device comprises a transparent substrate having a first main surface and a second main surface which faces the first main surface, a display element configured to emit display light toward the transparent substrate, an optical path adjustment element provided on the first main surface between the transparent substrate and the display element, a first optical element which is provided on the second main surface facing the optical path adjustment element and diffracts display light which passed through the transparent substrate so as to be totally reflected inside the transparent substrate, and a second optical element which is provided on the second main surface and diffracts display light which propagated inside the transparent substrate so as to be emitted from the first main surface. The optical path adjustment element is configured to adjust an optical path of display light to change an emission position of display light.

According to yet another embodiment, a light guide element comprises a transparent substrate having a first main surface and a second main surface which faces the first main surface, an optical path adjustment element provided on the second main surface, a first optical element which overlaps the optical path adjustment element and diffracts light which passed through the transparent substrate and the optical path adjustment element so as to be totally reflected inside the transparent substrate, and a second optical element which is provided on the second main surface and diffracts light which propagated inside the transparent substrate so as to be emitted from the first main surface. The optical path adjustment element is configured to adjust an optical path of incident light to change an emission position of light.

According to yet another embodiment, a light guide element comprises a transparent substrate having a first main surface and a second main surface which faces the first main surface, an optical path adjustment element provided on the first main surface, a first optical element which is provided on the second main surface facing the optical path adjustment element and diffracts light which passed through the transparent substrate so as to be totally reflected inside the transparent substrate, and a second optical element which is provided on the second main surface and diffracts light which propagated inside the transparent substrate so as to be emitted from the first main surface. The optical path adjustment element is configured to adjust an optical path of incident light to change an emission position of light.

Embodiments will be described hereinafter with reference to the accompanying drawings. The disclosure is merely an example, and proper changes in keeping with the spirit of the invention, which are easily conceivable by a person of ordinary skill in the art, come within the scope of the invention as a matter of course. In addition, in some cases, in order to make the description clearer, the widths, thicknesses, shapes, etc., of the respective parts are illustrated schematically in the drawings, rather than as an accurate representation of what is implemented. However, such schematic illustration is merely exemplary, and in no way restricts the interpretation of the invention. In addition, in the specification and drawings, structural elements which function in the same or a similar manner to those described in connection with preceding drawings are denoted by like reference numbers, detailed description thereof being omitted unless necessary.

In this specification, the term “light” includes visible light and invisible light. For example, the wavelength of the lower limit of the visible light range is greater than or equal to 350 nm and less than or equal to 400 nm. The wavelength of the upper limit of the visible light range is greater than or equal to 700 nm and less than or equal to 830 nm. Visible light includes the first component (blue component) of a first wavelength range (for example, 400 to 500 nm), the second component (green component) of a second wavelength range (for example, 500 to 600 nm), and the third component (red component) of a third wavelength range (for example, 600 to 700 nm). Invisible light includes ultraviolet light having a wavelength range in which the wavelength is shorter than the first wavelength range, and infrared light having a wavelength range in which the wavelength is longer than the third wavelength range.

In this specification, the term “transparent” should preferably mean colorless and transparent. However, the term “transparent” may mean semitransparent, or colored and transparent.

FIG. 1 is a cross-sectional view showing a configuration example of a display device DSP according to an embodiment.

The display device DSP comprises a light guide element LG and a display module DM. The display device DSP is held by frames 31 and 32.

The light guide element LG comprises a transparent substrate 1, a first optical element 11, a second optical element 12 and an optical path adjustment element AD. The display module DM comprises a display element 2 and an optical system 3.

The transparent substrate 1 consists of, for example, a transparent glass plate or a transparent synthetic resinous plate. The transparent substrate 1 may consist of, for example, a transparent synthetic resinous plate having flexibility. The transparent substrate 1 could have an arbitrary shape. For example, the transparent substrate 1 may be curved.

The transparent substrate 1 is formed into the shape of a flat plate, and has a first main surface 1A and a second main surface 1B which faces the first main surface 1A. The first main surface 1A and the second main surface 1B are surfaces parallel to each other.

The optical path adjustment element AD is provided on the second main surface 1B which faces the display element 2 as described in detail later. The first optical element 11 overlaps the optical path adjustment element AD. The optical path adjustment element AD is located between the transparent substrate 1 and the first optical element 11. For example, the optical path adjustment element AD is attached to the transparent substrate 1, and the first optical element 11 is attached to the optical path adjustment element AD.

The second optical element 12 is provided on the second main surface 1B which faces the eye E of the user, and is attached to the transparent substrate 1. The first optical element 11 and the second optical element 12 are diffractive elements which diffract incident light at a predetermined diffractive angle, and are, for example, holographic optical elements (HOEs). Each of the first optical element 11 and the second optical element 12 is, for example, a multilayer film in which an HOE which diffracts a blue component, an HOE which diffracts a green component and an HOE which diffracts a red component are stacked. It should be noted that, when only light having a specific wavelength is diffracted, each of the first optical element 11 and the second optical element 12 may be a single-layer film. Each of the first optical element 11 and the second optical element 12 may be a diffractive grating or mirror.

The display element 2 is configured to emit display light DL toward the transparent substrate 1. The display element 2 is provided on a side which faces the first main surface 1A of the transparent substrate 1. Thus, in the example shown in the figure, the display element 2 is located on a side opposite to the optical path adjustment element AD and the first optical element 11 across the intervening transparent substrate 1. This display element 2 may be, for example, a display element which comprises a self-luminous element, such as an organic electroluminescent element or a light emitting diode, or may be a display element in which an optical switch and an illumination device are combined with each other, such as a liquid crystal panel.

The optical system 3 is provided between the display element 2 and the transparent substrate 1. This optical system 3 comprises at least one lens and is configured to collimate divergent display light DL emitted from the display element 2.

The frame 31 accommodates the display module DM and has an aperture 31A which faces eye E. The light guide element LG is interposed and held between the frame 32 and the frame 31. The frame 32 has an aperture 32A which overlaps the aperture 31A. The second optical element 12 is located in the aperture 32A. In the example shown in the figure, the area of the second optical element 12 is less than that of the aperture 32A. It should be noted that the second optical element 12 may be provided over the entire area of the aperture 32A.

In this display device DSP, display light DL emitted from the display element 2 is collimated in the optical system 3 and subsequently enters the transparent substrate 1 substantially perpendicularly to the transparent substrate 1. Display light DL which passed through the transparent substrate 1 is diffracted in the first optical element 11 after passing through the optical path adjustment element AD. At this time, the first optical element 11 diffracts display light DL which passed through the transparent substrate 1 and the optical path adjustment element AD such that display light is totally reflected inside the transparent substrate 1. By this configuration, display light DL propagates inside the transparent substrate 1 while being totally reflected on the first main surface 1A and the second main surface 1B and is diffracted in the second optical element 12. At this time, the second optical element 12 diffracts display light DL so as to be substantially perpendicularly emitted from the first main surface 1A. Thus, display light DL which enters the transparent substrate 1 is substantially parallel to display light DL which is emitted from the transparent substrate 1. By this configuration, the user can visually recognize the image displayed in the display element 2 in the observation area where the second optical element 12 is provided in the apertures 32A and 32B. When the rear side of the display device DSP is released, the user can observe the background via the display device DSP.

This display device DSP can be applied to an eyeglasses-type or goggles-type head-mounted display and can be used to provide the user with virtual reality, augmented reality and the like.

The optical path adjustment element AD of the embodiment is configured to adjust the optical path of display light DL to change the emission position of display light DL. This configuration is explained below.

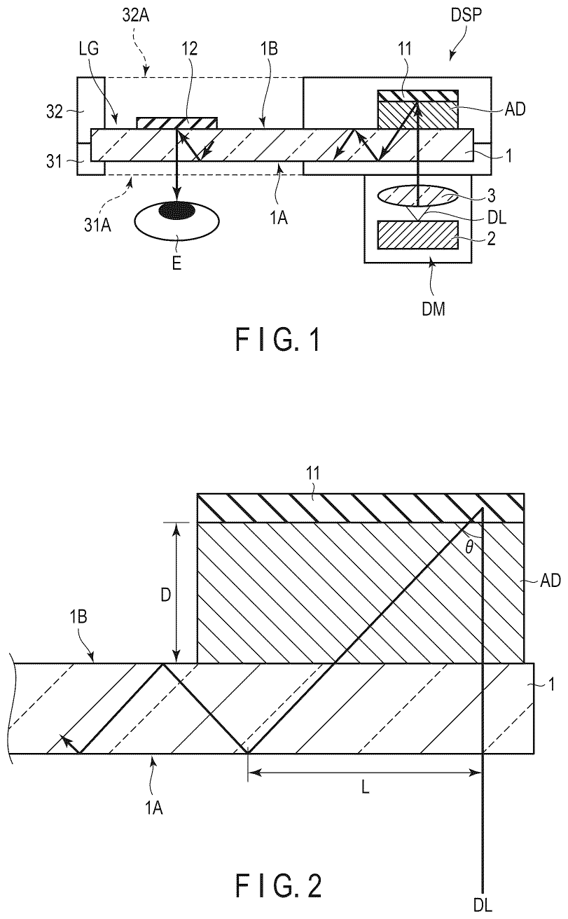

FIG. 2 is a diagram for explaining the definition of light guide length L.

The optical path adjustment element AD has thickness D. The first optical element 11 diffracts display light DL which is incident light at diffractive angle θ. At this time, the distance from the position at which display light DL enters the first main surface 1A to the position at which display light DL which is the diffracted light diffracted in the first optical element 11 is firstly totally reflected on the first main surface 1A is defined as light guide length L.

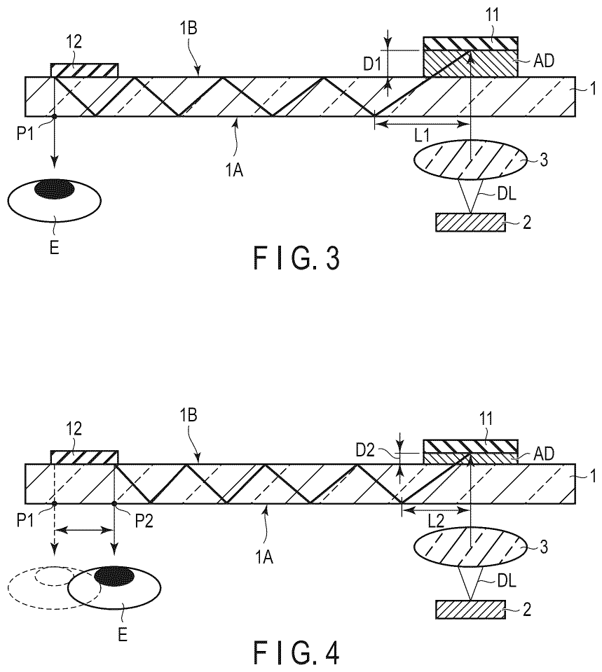

FIG. 3 is a diagram for explaining the effect of the optical path adjustment element AD.

The example shown in FIG. 3 corresponds to a case where thickness D1 of the optical path adjustment element AD is greater than the initial thickness. At this time, assuming that the diffractive angle of display light DL in the first optical element 11 is constant, the optical path length of the diffracted light in the optical path adjustment element AD is extended. In other words, when the optical path adjustment element AD has thickness D1, light guide length L1 which is longer than a case where the optical path adjustment element AD has the initial thickness is obtained. The emission position of display light DL diffracted in the second optical element 12 shifts to position P1 on the left side of the figure (a side moving away from the first optical element 11) compared with a case where the optical path adjustment element AD has the initial thickness.

FIG. 4 is a diagram for explaining the effect of the optical path adjustment element AD.

The example shown in FIG. 4 corresponds to a case where thickness D2 of the optical path adjustment element AD is less than the initial thickness. At this time, assuming that the diffractive angle of display light DL in the first optical element 11 is constant, the optical path length of the diffracted light in the optical path adjustment element AD is shortened. In other words, when the optical path adjustment element AD has thickness D2, light guide length L2 which is shorter than a case where the optical path adjustment element AD has the initial thickness is obtained. The emission position of display light DL diffracted in the second optical element 12 shifts to position P2 on the right side of the figure (a side approaching the first optical element 11) compared with a case where the optical path adjustment element AD has the initial thickness.

Thus, the emission position of display light DL can be adjusted in the range from position P1 shown in FIG. 3 to position P2 shown in FIG. 4 by adjusting the thickness of the optical path adjustment element AD in the range from thickness D1 shown in FIG. 3 to thickness D2 shown in FIG. 4. By adjusting the thickness of the optical path adjustment element AD, the observation area of images can be freely shifted.

The display device DSP of the embodiment is assumed to be used by a plurality of users having eyes E which are different from each other regarding the positions. For example, the position of eye E differs depending on a case where an adult uses the display device DSP or a case where a child uses the display device DSP. In this case, display light DL can be emitted to an appropriate place corresponding to the position of eye E of each user by adjusting the thickness of the optical path adjustment element AD.

In this manner, the reduction in the visibility of images can be prevented without giving each user uncomfortable feeling.

Now, this specification explains several configuration examples for adjusting the thickness of the optical path adjustment element AD.

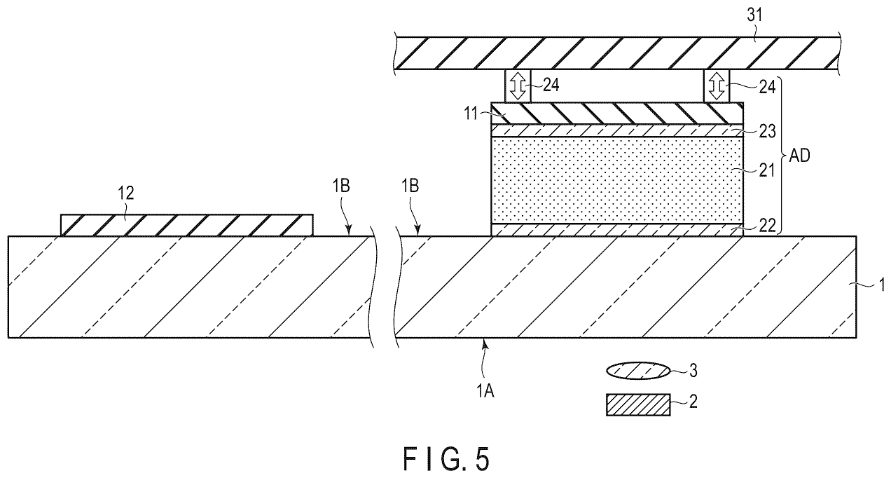

FIG. 5 is a cross-sectional view showing a configuration example of the optical path adjustment element AD which can be applied to the display device DSP shown in FIG. 1.

The optical path adjustment element AD comprises an elastic layer 21 provided between the transparent substrate 1 and the first optical element 11, and a variable mechanism 24 for making the thickness of the elastic layer 21 variable. In the example shown in the figure, the elastic layer 21 is interposed and held between a support body 22 and a support body 23. Each of the support body 22 and the support body 23 is a transparent glass plate or a transparent synthetic resinous plate. The support body 22 is attached to the transparent substrate 1. The support body 23 is attached to the first optical element 11. The variable mechanism 24 is provided between the frame 31 and the first optical element 11 and is configured to be stretchable in the normal direction of the frame 31. The variable mechanism 24 can be operated by hand or may be controlled by electric signals. The interval between the frame 31 and the transparent substrate 1 cannot be changed.

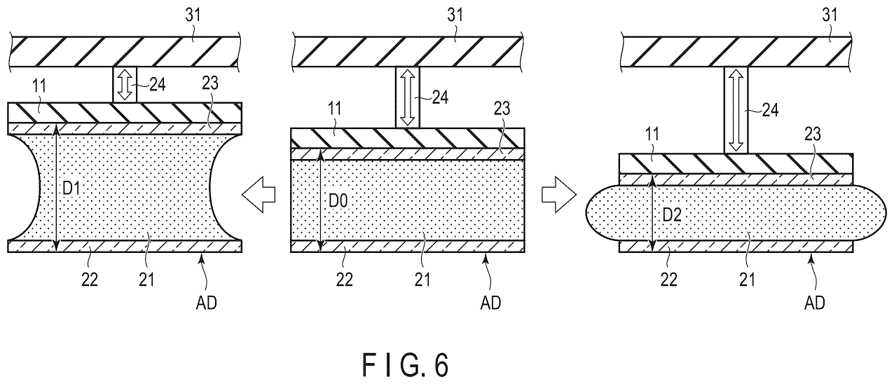

FIG. 6 is a diagram for explaining the state of the optical path adjustment element AD.

In the example shown in FIG. 6, the elastic layer 21 is formed of a transparent resin. For the materials which are suitable for the elastic layer 21, a silicone resin, an ethylene propylene resin (EPDM) and the like are considered.

In the figure, the middle cross-sectional view shows the initial state of the optical path adjustment element AD. At this time, the optical path adjustment element AD has thickness DO.

In the figure, the left cross-sectional view shows a state where, compared to the initial state, the variable mechanism 24 is shrunk toward the frame 31, and the elastic layer 21 is stretched in the thickness direction (or the normal direction of the frame 31). At this time, the optical path adjustment element AD has thickness D1 which is greater than thickness DO. Thus, in a state where the optical path adjustment element AD is stretched, as explained with reference to FIG. 3, the emission position of display element DL diffracted in the second optical element 12 shifts to position P1 on the left side of the figure compared to the initial state.

In the figure, the right cross-sectional view shows a state where, compared to the initial state, the variable mechanism 24 is stretched toward the first optical element 11, and the elastic layer 21 is shrunk in the thickness direction. At this time, the optical path adjustment element AD has thickness D2 which is less than thickness DO. Thus, in a state where the optical path adjustment element AD is shrunk, as explained with reference to FIG. 4, the emission position of display light DL diffracted in the second optical element 12 shifts to position P2 on the right side of the figure compared to the initial state.

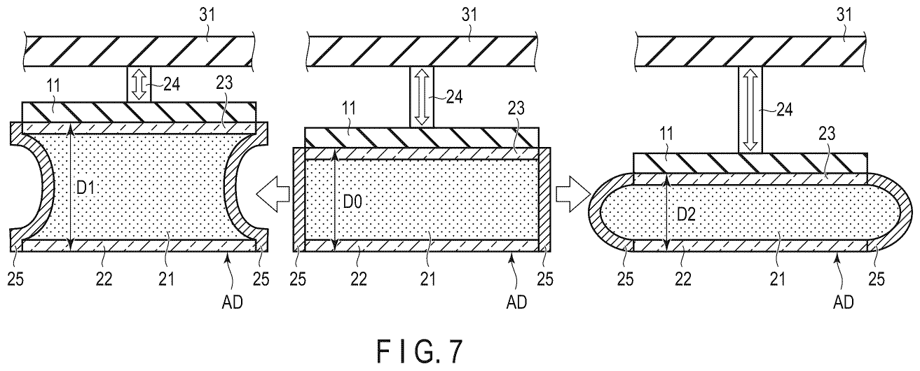

FIG. 7 is a diagram for explaining the state of the optical path adjustment element AD.

In the example shown in FIG. 7, the elastic layer 21 is formed of a transparent liquid. For the materials which are suitable for the elastic layer 21, water, a silicone oil, a hydroxypropyl cellulose solution, a polyvinyl alcohol solution and the like are considered. When the elastic layer 21 is a liquid, the elastic layer 21 is sealed by a sealing film 25. The sealing film 25 is formed of a material having elasticity.

In the figure, the middle cross-sectional view shows the initial state of the optical path adjustment element AD. At this time, the optical path adjustment element AD has thickness DO.

In the figure, the left cross-sectional view shows a state where, compared to the initial state, the variable mechanism 24 is shrunk toward the frame 31, and the elastic layer 21 is stretched in the thickness direction. At this time, the optical path adjustment element AD has thickness D1 which is greater than thickness DO. Thus, in a state where the optical path adjustment element AD is stretched, as explained with reference to FIG. 3, the emission position of display light DL diffracted in the second optical element 12 shifts to position P1 on the left side of the figure compared to the initial state.

In the figure, the right cross-sectional view shows a state where, compared to the initial state, the variable mechanism 24 is stretched toward the first optical element 11, and the elastic layer 21 is shrunk in the thickness direction. At this time, the optical adjustment element AD has thickness D2 which is less than thickness DO. Thus, in a state where the optical path adjustment element AD is shrunk, as explained with reference to FIG. 4, the emission position of display light DL diffracted in the second optical element 12 shifts to position P2 on the right side of the figure compared to the initial state.

The method of changing the emission position of display light DL is realized by adjusting the thickness of the optical path adjustment element AD in the configuration example explained with reference to FIG. 5 to FIG. 7. However, the method is not limited to this example. The emission position of display light DL may be changed by refracting display light DL which passes through the optical path adjustment element AD.

In the description below, this specification explains several configuration examples for refracting display light DL inside the optical path adjustment element AD.

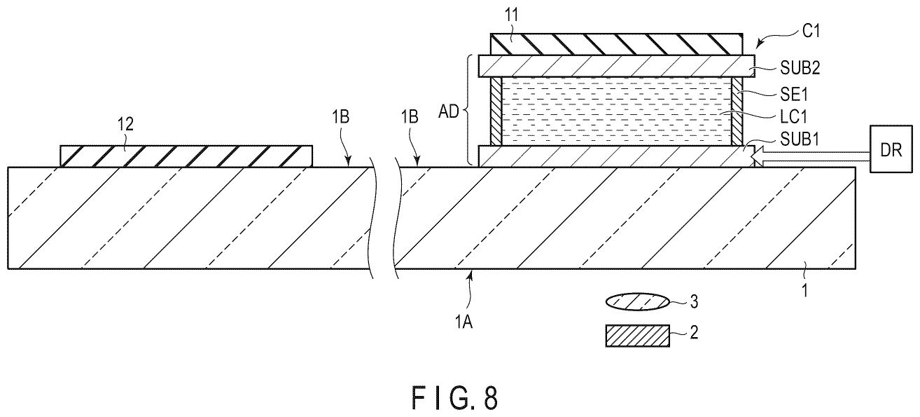

FIG. 8 is a cross-sectional view showing another configuration example of the optical path adjustment element AD which can be applied to the display device DSP shown in FIG. 1.

The optical path adjustment element AD comprises a first liquid crystal cell C1 between the transparent substrate 1 and the first optical element 11. The first liquid crystal cell C1 comprises a first substrate SUB1, a second substrate SUB2 and a first liquid crystal layer LC1. The first substrate SUB1 is attached to the second main surface 1B of the transparent substrate 1. The second substrate SUB2 faces the first substrate SUB1. The first liquid crystal layer LC1 is held between the first substrate SUB1 and the second substrate SUB2, and is sealed by a sealant SE1.

This first liquid crystal cell C1 is driven by a driver DR. Thus, the refractive index distribution of the first liquid crystal layer LC1 is controlled.

The first optical element 11 is attached to the second substrate SUB2.

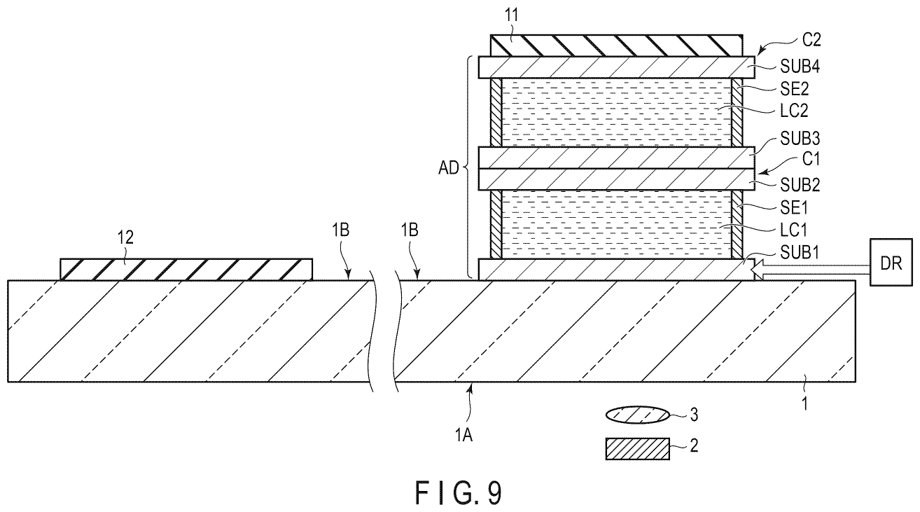

FIG. 9 is a cross-sectional view showing another configuration example of the optical path adjustment element AD which can be applied to the display device DSP shown in FIG. 1.

The optical path adjustment element AD comprises a first liquid crystal cell C1 and a second liquid crystal cell C2 between the transparent substrate 1 and the first optical element 11. The configuration of the first liquid crystal cell C1 is as explained with reference to FIG. 8, explanation thereof being omitted.

The second liquid crystal cell C2 comprises a third substrate SUB3, a fourth substrate SUB4 and a second liquid crystal layer LC2. The third substrate SUB3 is attached to the second substrate SUB2. The fourth substrate SUB4 faces the third substrate SUB3. The second liquid crystal layer LC2 is held between the third substrate SUB3 and the fourth substrate SUB4, and is sealed by a sealant SE2.

These first liquid crystal cell C1 and second liquid crystal cell C2 are driven by a driver DR. Thus, the refractive index distribution of each of the first liquid crystal layer LC1 and the second liquid crystal layer LC2 is controlled.

The first optical element 11 is attached to the fourth substrate SUB4.

The optical path adjustment element AD comprises at least one liquid crystal cell as shown in FIG. 8 and FIG. 9, and may be configured by stacking three or more liquid crystal cells.

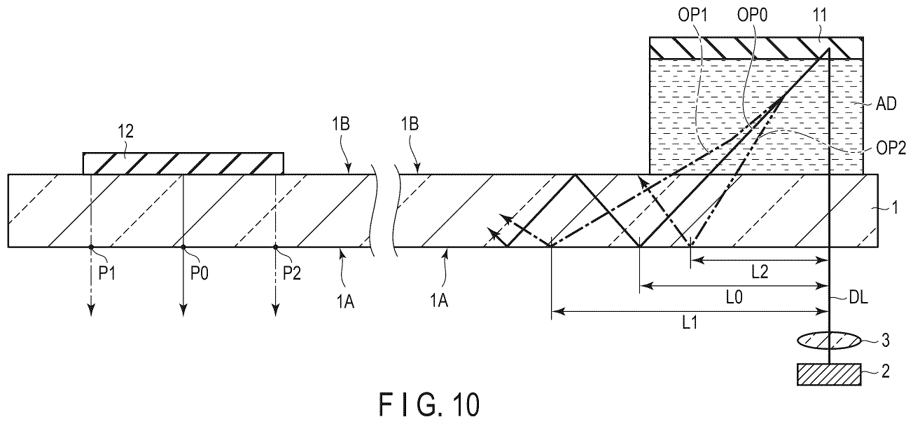

FIG. 10 is a diagram for explaining the effect of the optical path adjustment element AD comprising a liquid crystal cell.

When the refractive index distribution of the liquid crystal cell is in the initial state in the optical path adjustment element AD, display light DL passes through route OP0 shown by the solid line in the optical path adjustment element AD and is totally reflected on the first main surface 1A of the transparent substrate 1. At this time, light guide length L0 is obtained. The emission position of display light DL diffracted in the second optical element 12 is position P0.

When the refractive index distribution of the liquid crystal cell is in a state which is different from the initial state in the optical path adjustment element AD, display light DL is refracted in the optical path adjustment element AD, passes through a route which is different from route OP0 and is totally reflected on the first main surface 1A of the transparent substrate 1.

When display light DL passes through route OP1 shown by the one-dot chain line, the optical path length of the diffracted light in the optical path adjustment element AD is extended compared to the initial state. At this time, light guide length L1 which is longer than light guide length L0 is obtained. The emission position of display light DL diffracted in the second optical element 12 shifts to position P1 on the left side of the figure (a side moving away from the first optical element 11) compared to position P0 in the initial state.

When display light DL passes through route OP2 shown by the two-dot chain line, the optical path length of the diffracted light in the optical path adjustment element AD is shortened compared to the initial state. At this time, light guide length L2 which is shorter than light guide length L0 is obtained. The emission position of display light DL diffracted in the second optical element 12 shifts to position P2 on the right side of the figure (a side approaching the first optical element 11) compared to position P0 in the initial state.

In this manner, the emission position of display light DL can be adjusted in the range from position P1 to position P2 by controlling the refractive index distribution of the liquid crystal cell constituting the optical path adjustment element AD. Thus, the observation area of images can be freely shifted by adjusting the refractive index distribution.

In this configuration example, effects similar to those of the above description are obtained.

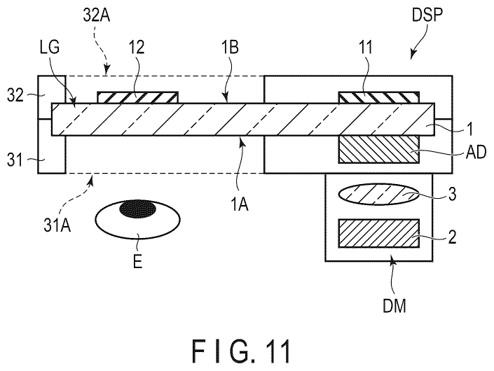

FIG. 11 is a cross-sectional view showing another configuration example of the display device DSP.

The configuration example shown in FIG. 11 is different from that shown in FIG. 1 in respect that the optical path adjustment element AD is located between the display element 2 or the display module DM and the transparent substrate 1 and is provided on the first surface 1A of the transparent substrate 1. The first optical element 11 is provided on the second main surface 1B which faces the optical path adjustment element AD. The second optical element 12 is provided on the second main surface 1B which faces the eye E of the user. For example, all of the first optical element 11, the second optical element 12 and the optical path adjustment element AD are attached to the transparent substrate 1.

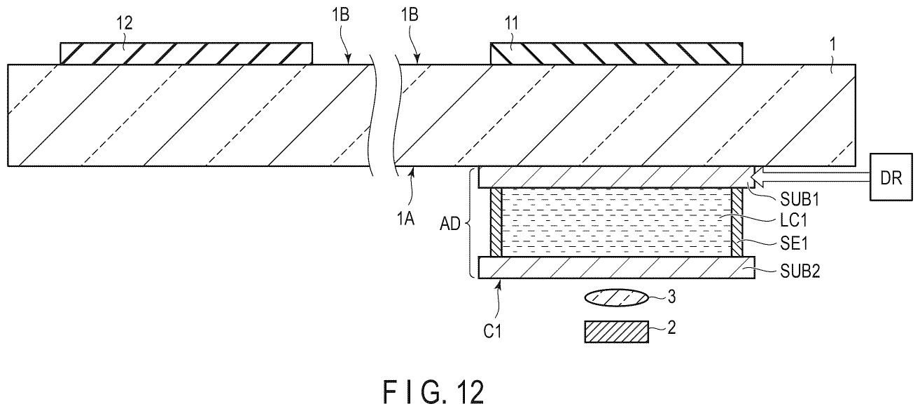

FIG. 12 is a cross-sectional view showing a configuration example of the optical path adjustment element AD which can be applied to the display device DSP shown in FIG. 11.

The optical path adjustment element AD comprises a first liquid crystal cell C1 between the display element 2 and the transparent substrate 1. The first liquid crystal cell C1 comprises a first substrate SUB1, a second substrate SUB2 and a first liquid crystal layer LC1. The first substrate SUB1 is attached to the first main surface 1A of the transparent substrate 1. The second substrate SUB2 faces the first substrate SUB1. The first liquid crystal layer LC1 is held between the first substrate SUB1 and the second substrate SUB2, and is sealed by a sealant SE1.

This first liquid crystal cell C1 is driven by a driver DR. Thus, the refractive index distribution of the first liquid crystal layer LC1 is controlled.

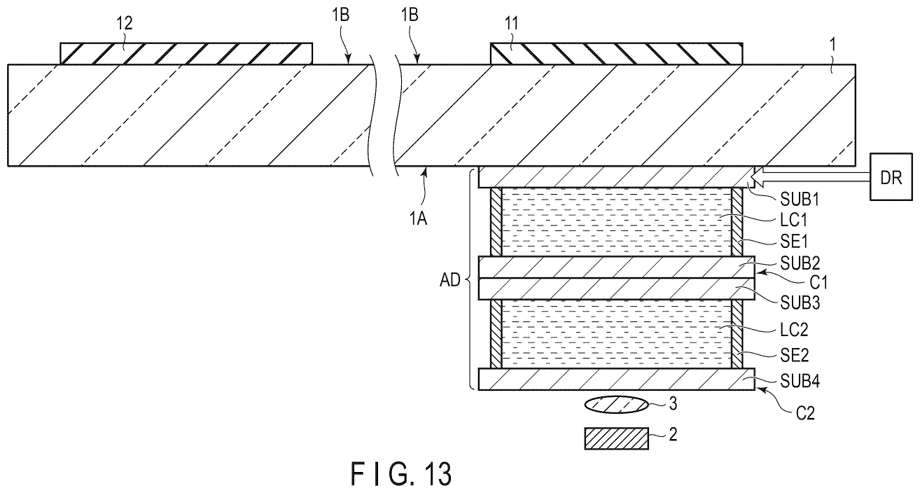

FIG. 13 is a cross-sectional view showing another configuration example of the optical path adjustment element AD which can be applied to the display device DSP shown in FIG. 11.

The optical path adjustment element AD comprises a first liquid crystal cell C1 and a second liquid crystal cell C2 between the display element 2 and the transparent substrate 1. The configuration of the first liquid crystal cell C1 is as explained with reference to FIG. 12, explanation thereof being omitted.

The second liquid crystal cell C2 comprises a third substrate SUB3, a fourth substrate SUB4 and a second liquid crystal layer LC2. The third substrate SUB3 is attached to the second substrate SUB2. The fourth substrate SUB4 faces the third substrate SUB3. The second liquid crystal layer LC2 is held between the third substrate SUB3 and the fourth substrate SUB4, and is sealed by a sealant SE2.

These first liquid crystal cell C1 and second liquid crystal cell C2 are driven by a driver DR. Thus, the refractive index distribution of each of the first liquid crystal layer LC1 and the second liquid crystal layer LC2 is controlled.

The optical path adjustment element AD comprises at least one liquid crystal cell as shown in FIG. 12 and FIG. 13, and may be configured by stacking three or more liquid crystal cells.

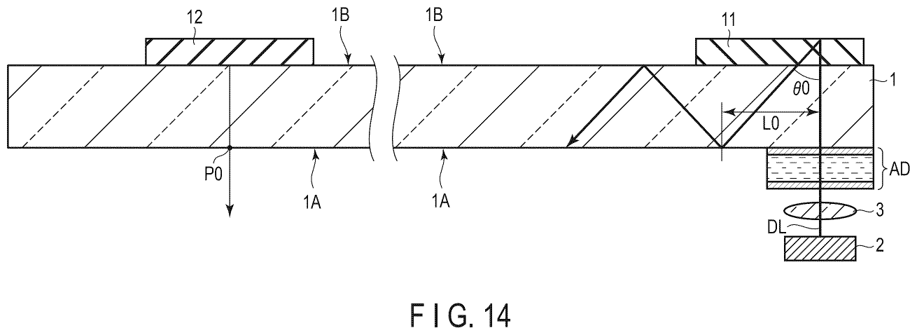

FIG. 14 is a diagram for explaining the effect of the optical path adjustment element AD comprising a liquid crystal cell.

When the refractive index distribution of the liquid crystal cell is in the initial state in the optical path adjustment element AD, display light DL travels in substantially a straight line in the optical path adjustment element AD, passes through the transparent substrate 1 and is subsequently diffracted in the first optical element 11 at diffractive angle θ0. The diffracted light is totally reflected on the first main surface 1A. At this time, light guide length L0 is obtained. The emission position of display light DL diffracted in the second optical element 12 is position P0.

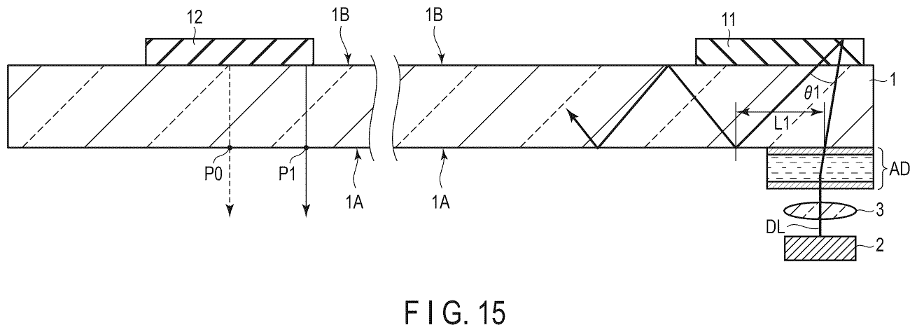

FIG. 15 is a diagram for explaining the effect of the optical path adjustment element AD comprising a liquid crystal cell.

In the optical path adjustment element AD, the refractive index distribution of the liquid crystal cell is in a state which is different from the initial state. In the example shown in FIG. 15, display light DL is refracted in the optical path adjustment element AD, bends to the right side of the figure, passes through the transparent substrate 1 and is subsequently diffracted in the first optical element 11 at diffractive angle θ1. Diffractive angle θ1 is less than diffractive angle θ0 (01<00). The diffracted light is totally reflected on the first main surface 1A of the transparent substrate 1. At this time, light guide length L1 which is shorter than light guide length L0 is obtained. The emission position of display light DL diffracted in the second optical element 12 shifts to position P1 on the right side of the figure (a side approaching the first optical element 11) compared to position P0 in the initial state.

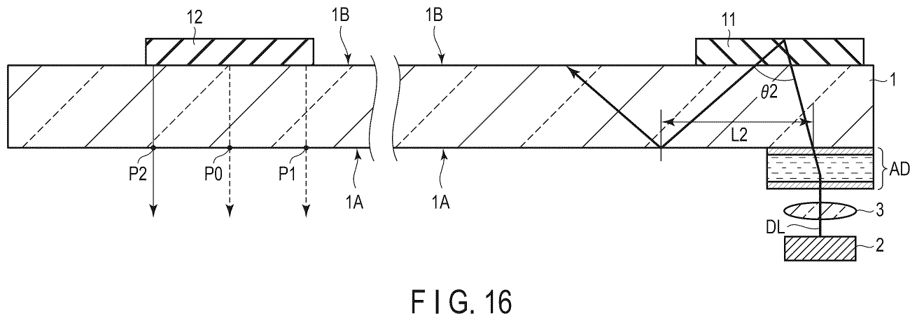

FIG. 16 is a diagram for explaining the effect of the optical path adjustment element AD comprising a liquid crystal cell.

In the optical path adjustment element AD, the refractive index distribution of the liquid crystal cell is in a state which is different from the initial state. In the example shown in FIG. 16, display light DL is refracted in the optical path adjustment element AD, bends to the left side of the figure, passes through the transparent substrate 1 and is subsequently diffracted in the first optical element 11 at diffractive angle θ2. Diffractive angle θ2 is greater than diffractive angle θ0 (θ0<θ2). The diffracted light is totally reflected on the first main surface 1A of the transparent substrate 1. At this time, light guide length L2 which is longer than light guide length L0 is obtained. The emission position of display light DL diffracted in the second optical element 12 shifts to position P2 on the left side of the figure (a side moving away from the first optical element 11) compared to position P0 in the initial state.

In this manner, the emission position of display light DL can be adjusted in the range from position P1 to position P2 by controlling the refractive index distribution of the liquid crystal cell constituting the optical path adjustment element AD. Thus, the observation area of images can be freely shifted by adjusting the refractive index distribution.

In this configuration example, effects similar to those of the above description are obtained.

Now, this specification explains several configuration examples for controlling the refractive index distribution of the optical path adjustment element AD.

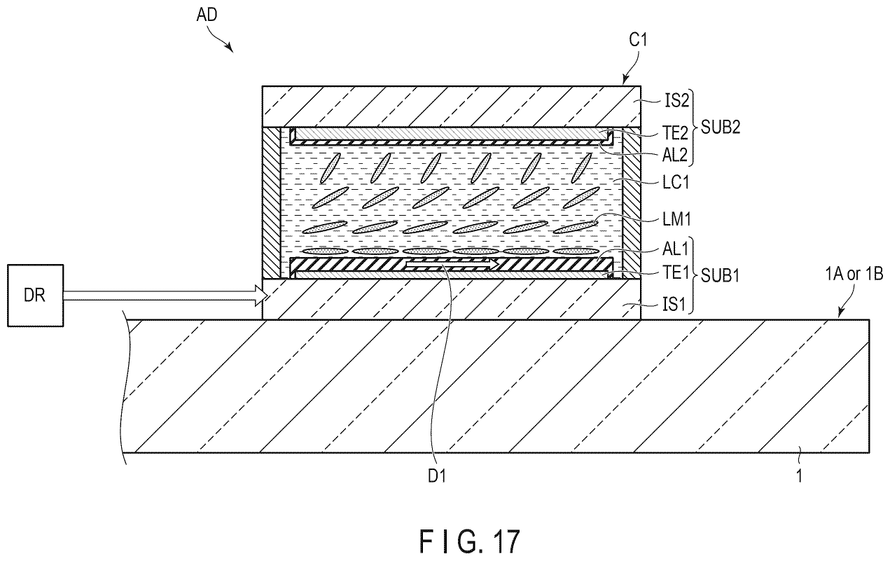

FIG. 17 is a cross-sectional view showing a configuration example of the optical path adjustment element AD.

The configuration example shown in FIG. 17 can be applied to the optical path adjustment element AD shown in each of FIG. 8 and FIG. 12. The first liquid crystal cell C1 constituting the optical path adjustment element AD comprises the first substrate SUB1, the second substrate SUB2 and the first liquid crystal layer LC1.

The first substrate SUB1 comprises a transparent first insulating substrate IS1, a first transparent electrode TE1, and a first horizontal alignment film AL1 which covers the first transparent electrode TE1. The first insulating substrate IS1 is attached to the first main surface 1A or second main surface 1B of the transparent substrate 1. The first transparent electrode TE1 is a simple electrode provided on substantially the entire surface of the first insulating substrate IS1. Alignment treatment direction D1 of the first horizontal alignment film AL1 is, for example, a direction from left to right in the figure.

The second substrate SUB2 comprises a transparent second insulating substrate IS2, a second transparent electrode TE2, and a first perpendicular alignment film AL2 which covers the second transparent electrode TE2. The second transparent electrode TE2 is a simple electrode provided on substantially the entire surface of the second insulating substrate IS2. The driver DR controls the application voltage of the first transparent electrode TEL and the second transparent electrode TE2.

A state in which no voltage is applied to the first transparent electrode TEL or the second transparent electrode TE2, in other words, a state in which no electric field is formed in the first liquid crystal layer LC1, is referred to as an off state (OFF). A state in which voltage is applied to the first transparent electrode TE1 and the second transparent electrode TE2, in other words, a state in which an electric field is formed in the first liquid crystal layer LC1, is referred to as an on state (ON).

The first liquid crystal layer LC1 is held between the first substrate SUB1 and the second substrate SUB2 and is in contact with the first horizontal alignment film AL1 and the first perpendicular alignment film AL2. The liquid crystal molecules LM1 contained in the first liquid crystal layer LC1 are aligned in a hybrid alignment manner in an off state. In other words, the liquid crystal molecules LM1 located near the first horizontal alignment film AL1 are substantially horizontally aligned along the main surface of the first insulating substrate IS1. The liquid crystal molecules LM1 located near the first perpendicular alignment film AL2 are substantially perpendicularly aligned along the normal of the second insulating substrate IS2.

This first liquid crystal layer LC1 may be a positive liquid crystal layer in which, relative to the perpendicular electric field between the first transparent electrode TEL and the second transparent electrode TE2, the long axes of the liquid crystal molecules LM1 are aligned so as to be parallel to the electric field, or may be a negative liquid crystal layer in which the long axes of the liquid crystal molecules LM1 are aligned so as to intersect with the electric field.

It should be noted that the alignment film of the first substrate SUB1 may be the first perpendicular alignment film, and the alignment film of the second substrate SUB2 may be the first horizontal alignment film.

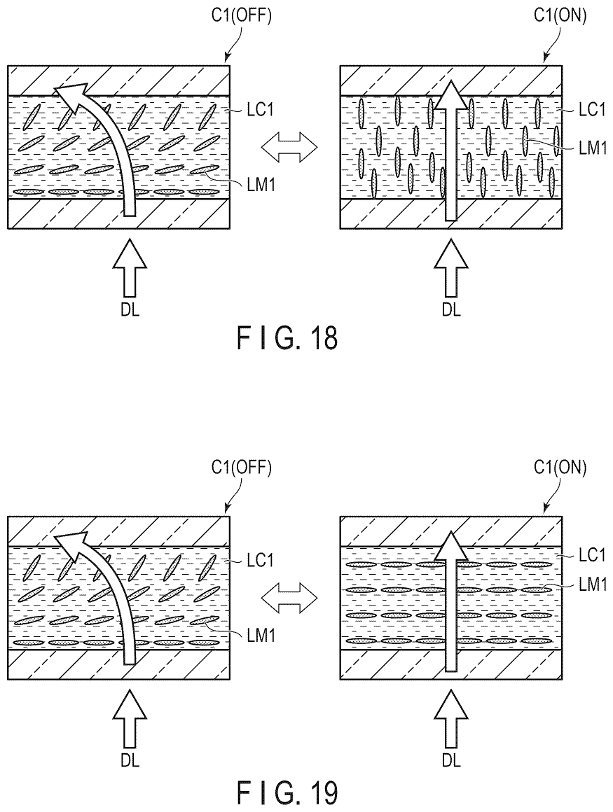

FIG. 18 is a diagram for explaining a relationship between the refractive index distribution of the first liquid crystal cell C1 shown in FIG. 17 and display light DL.

In the example shown in FIG. 18, the first liquid crystal layer LC1 is a positive liquid crystal layer.

The left side of the figure shows a case where the first liquid crystal cell C1 is in an off state (OFF). The liquid crystal molecules LM1 are aligned in a hybrid alignment manner in the first liquid crystal layer LC1. Display light DL passes through the first liquid crystal cell C1 while being affected by a nonuniform refractive index distribution. By this effect, display light DL is refracted, and bends to the left side of the figure.

The right side of the figure shows a case where the first liquid crystal cell C1 is in an on state (ON). The liquid crystal molecules LM1 are substantially uniformly perpendicularly aligned in the first liquid crystal layer LC1. Display light DL passes through the first liquid crystal cell C1 while being affected by substantially a uniform refractive index distribution. By this effect, display light DL travels in a straight line substantially without being refracted.

FIG. 19 is a diagram for explaining another relationship between the refractive index distribution of the first liquid crystal cell C1 shown in FIG. 17 and display light DL.

In the example shown in FIG. 19, the first liquid crystal layer LC1 is a negative liquid crystal layer.

The left side of the figure shows a case where the first liquid crystal cell C1 is in an off state (OFF). The liquid crystal molecules LM1 are aligned in a hybrid alignment manner in the first liquid crystal layer LC1. At this time, display light DL is refracted in a manner similar to that of the off state shown in FIG. 18 and bends to the left side of the figure.

The right side of the figure shows a case where the first liquid crystal cell C1 is in an on state (ON). The liquid crystal molecules LM1 are substantially uniformly horizontally aligned in the first liquid crystal layer LC1. Display light DL passes through the first liquid crystal cell C1 while being affected by substantially a uniform refractive index distribution. By this effect, display light DL travels in a straight line substantially without being refracted.

As shown in FIG. 18 and FIG. 19, when the first liquid crystal cell C1 is in an off state, display light DL bends to left, and for example, as shown in FIG. 16, display light DL is emitted at position P2. When the first liquid crystal cell C1 is in an on state, display light DL travels in a straight line, and for example, as shown in FIG. 14, display light DL is emitted at position P0.

Thus, the emission position of display light DL can be adjusted in the range from position P0 to position P2 by controlling the refractive index distribution of the first liquid crystal layer LC1.

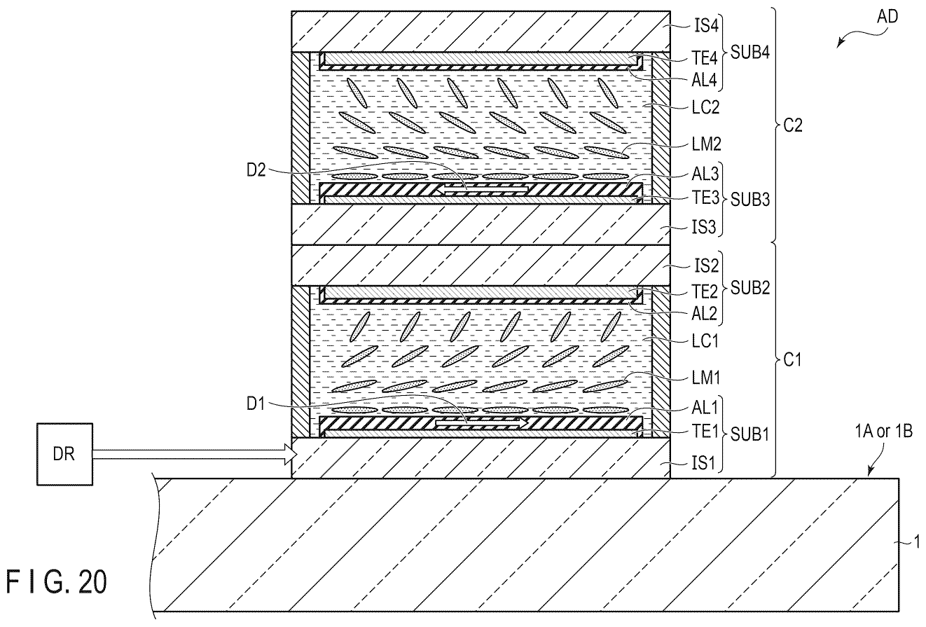

FIG. 20 is a cross-sectional view showing another configuration example of the optical path adjustment element AD.

The configuration example shown in FIG. 20 can be applied to the optical path adjustment element AD shown in each of FIG. 9 and FIG. 13. The first liquid crystal cell C1 constituting the optical path adjustment element AD comprises the first substrate SUB1, the second substrate SUB2 and the first liquid crystal layer LC1. The configuration of the first liquid crystal cell C1 is as explained with reference to FIG. 17, explanation thereof being omitted.

The second liquid crystal cell C2 constituting the optical path adjustment element AD comprises the third substrate SUB3, the fourth substrate SUB4 and the second liquid crystal layer LC2.

The third substrate SUB3 comprises a transparent third insulating substrate IS3, a third transparent electrode TE3, and a second horizontal alignment film AL3 which covers the third transparent electrode TE3. The third insulating substrate IS3 is attached to the second insulating substrate IS2. The third transparent electrode TE3 is a simple electrode provided on substantially the entire surface of the third insulating substrate IS3. Alignment treatment direction D2 of the second horizontal alignment film AL3 is parallel to alignment treatment direction D1, and further, is a direction opposite to alignment treatment direction D1 (a direction from right to left in the figure).

The fourth substrate SUB4 comprises a transparent fourth insulating substrate IS4, a fourth transparent electrode TE4, and a second perpendicular alignment film AL4 which covers the fourth transparent electrode TE4. The fourth transparent electrode TE4 is a simple electrode provided on substantially the entire surface of the fourth insulating substrate IS4. The driver DR controls the application voltage of the third transparent electrode TE3 and the fourth transparent electrode TE4.

A state in which no voltage is applied to the third transparent electrode TE3 or the fourth transparent electrode TE4, in other words, a state in which no electric field is formed in the second liquid crystal layer LC2, is referred to as an off state (OFF). A state in which voltage is applied to the third transparent electrode TE3 and the fourth transparent electrode TE4, in other words, a state in which an electric field is formed in the second liquid crystal layer LC2, is referred to as an on state (ON).

The second liquid crystal layer LC2 is held between the third substrate SUB3 and the fourth substrate SUB4 and is in contact with the second horizontal alignment film AL3 and the second perpendicular alignment film AL4. The liquid crystal molecules LM2 contained in the second liquid crystal layer LC2 are aligned in a hybrid alignment manner in an off state. In other words, the liquid crystal molecules LM2 located near the second horizontal alignment film AL3 are substantially horizontally aligned along the main surface of the first insulating substrate IS3. The liquid crystal molecules LM2 located near the second perpendicular alignment film AL4 are substantially perpendicularly aligned along the normal of the fourth insulating substrate IS4.

This second liquid crystal layer LC2 may be a positive liquid crystal layer in which, relative to the perpendicular electric field between the third transparent electrode TE3 and the fourth transparent electrode TE4, the long axes of the liquid crystal molecules LM2 are aligned so as to be parallel to the electric field, or may be a negative liquid crystal layer in which the long axes of the liquid crystal molecules LM2 are aligned so as to intersect with the electric field.

It should be noted that the alignment film of the third substrate SUB3 may be the second perpendicular alignment film, and the alignment film of the fourth substrate SUB4 may be the second horizontal alignment film.

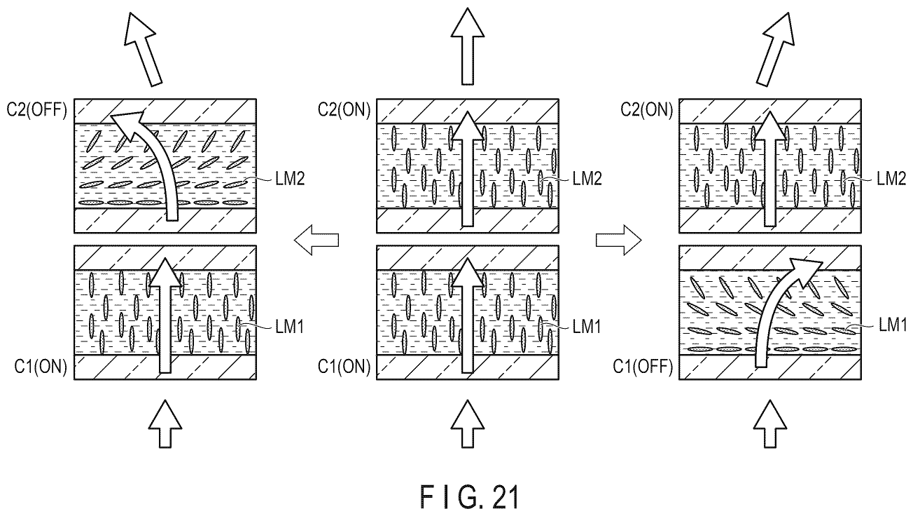

FIG. 21 is a diagram for explaining a relationship between the refractive index distributions of the first liquid crystal cell C1 and second liquid crystal cell C2 shown in FIG. 20 and display light DL.

In the example shown in FIG. 21, each of the first liquid crystal layer LC1 and the second liquid crystal layer LC2 is a positive liquid crystal layer.

The center of the figure shows a case where the first liquid crystal cell C1 and the second liquid crystal cell C2 are in an on state (ON). In the first liquid crystal layer LC1, the liquid crystal molecules LM1 are substantially uniformly perpendicularly aligned. In the second liquid crystal layer LC2, the liquid crystal molecules LM2 are substantially uniformly perpendicularly aligned. Display light DL travels in a straight line substantially without being refracted in the first liquid crystal cell C1, and subsequently travels in a straight line substantially without being refracted in the second liquid crystal cell C2. Thus, display light DL is emitted at position P0 as shown in, for example, FIG. 14.

The left side of the figure shows a case where the first liquid crystal cell C1 is in an on state (ON), and the second liquid crystal cell C2 is in an off state (OFF). In the first liquid crystal layer LC1, the liquid crystal molecules LM1 are substantially uniformly perpendicularly aligned. In the second liquid crystal layer LC2, the liquid crystal molecules LM2 are aligned in a hybrid alignment manner. Display light DL travels in a straight line substantially without being refracted in the first liquid crystal cell C1, is subsequently refracted in the second liquid crystal cell C2 and bends to the left side of the figure. Thus, display light DL is emitted at position P2 as shown in, for example, FIG. 16.

The right side of the figure shows a case where the first liquid crystal cell C1 is in an off state (OFF), and the second liquid crystal cell C2 is in an on state (ON). In the first liquid crystal layer LC1, the liquid crystal molecules LM1 are aligned in a hybrid alignment manner. In the second liquid crystal layer LC2, the liquid crystal molecules LM2 are substantially uniformly perpendicularly aligned. Display light DL is refracted in the first liquid crystal cell C1, bends to the right side of the figure and is not substantially refracted in the second liquid crystal cell C2. As a result, display light DL which passed through the first liquid crystal cell C1 and the second liquid crystal cell C2 bend to the right side of the figure. Thus, display light DL is emitted at position P1 as shown in, for example, FIG. 15.

In this manner, the emission position of display light DL can be adjusted in the range from position P1 to position P2 by controlling the refractive index distributions of the first liquid crystal layer LC1 and the second liquid crystal layer LC2.

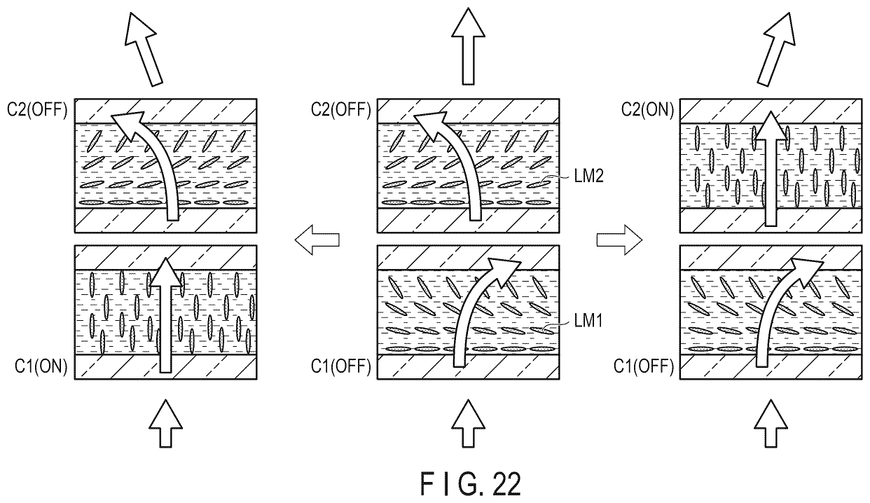

FIG. 22 is a diagram for explaining another relationship between the refractive index distributions of the first liquid crystal cell C1 and second liquid crystal cell C2 shown in FIG. 20 and display light DL.

In the example shown in FIG. 22, each of the first liquid crystal layer LC1 and the second liquid crystal layer LC2 is a positive liquid crystal layer.

The center of the figure shows a case where the first liquid crystal cell C1 and the second liquid crystal cell C2 are in an off state (OFF). In the first liquid crystal layer LC1, the liquid crystal molecules LM1 are aligned in a hybrid alignment manner. In the second liquid crystal layer LC2, the liquid crystal molecules LM2 are aligned in a hybrid alignment manner. Display light DL is refracted in the first liquid crystal cell C1 and bends to the right side. Further, display light DL is refracted in the second liquid crystal cell C2 and bends to the left side. As a result, display light DL which passed through the first liquid crystal cell C1 and the second liquid crystal cell C2 travels in substantially a straight line. Thus, display light DL is emitted at position P0 as shown in, for example, FIG. 14.

The left side of the figure shows a case where the first liquid crystal cell C1 is in an on state (ON), and the second liquid crystal cell C2 is in an off state (OFF). In this case, in a manner similar to that of the example shown on the left side of FIG. 21, display light DL which passed through the first liquid crystal cell C1 and the second liquid crystal cell C2 bends to the left side. Thus, display light DL is emitted at position P2 as shown in, for example, FIG. 16.

The right side of the figure shows a case where the first liquid crystal cell C1 is in an off state (OFF), and the second liquid crystal cell C2 is in an on state (ON). In this case, in a manner similar to that of the example shown on the right side of FIG. 21, display light DL which passed through the first liquid crystal cell C1 and the second liquid crystal cell C2 bends to the right side. Thus, display light DL is emitted at position P1 as shown in, for example, FIG. 15.

In this manner, the emission position of display light DL can be adjusted in the range from position P1 to position P2 by controlling the refractive index distributions of the first liquid crystal layer LC1 and the second liquid crystal layer LC2.

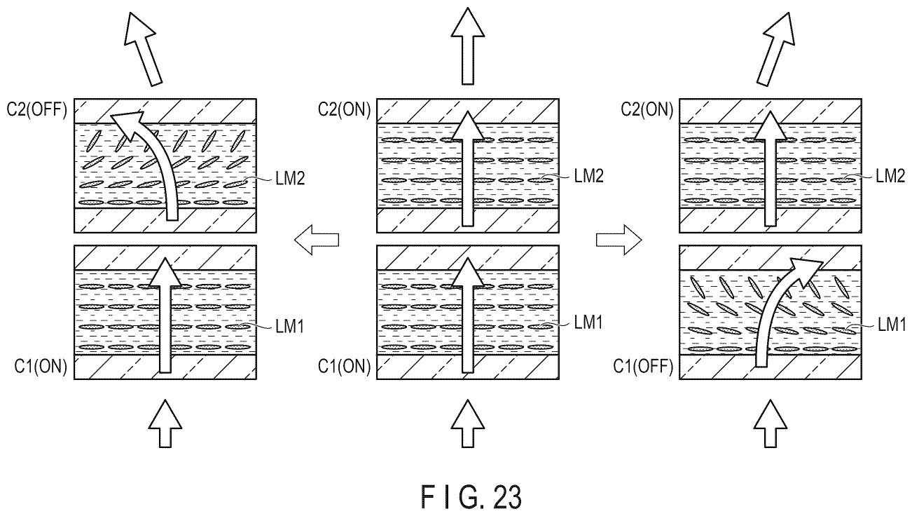

FIG. 23 is a diagram for explaining another relationship between the refractive index distributions of the first liquid crystal cell C1 and second liquid crystal cell C2 shown in FIG. 20 and display light DL.

In the example shown in FIG. 23, each of the first liquid crystal layer LC1 and the second liquid crystal layer LC2 is a negative liquid crystal layer.

The center of the figure shows a case where the first liquid crystal cell C1 and the second liquid crystal cell C2 are in an on state (ON). In the first liquid crystal layer LC1, the liquid crystal molecules LM1 are substantially uniformly horizontally aligned. In the second liquid crystal layer LC2, the liquid crystal molecules LM2 are substantially uniformly horizontally aligned. Display light DL travels in a straight line substantially without being refracted in the first liquid crystal cell C1, and subsequently travels in a straight line substantially without being refracted in the second liquid crystal cell C2. Thus, display light DL is emitted at position P0 as shown in, for example, FIG. 14.

The left side of the figure shows a case where the first liquid crystal cell C1 is in an on state (ON), and the second liquid crystal cell C2 is in an off state (OFF). In the first liquid crystal layer LC1, the liquid crystal molecules LM1 are substantially uniformly horizontally aligned. In the second liquid crystal layer LC2, the liquid crystal molecules LM2 are aligned in a hybrid alignment manner. Display light DL travels in a straight line substantially without being refracted in the first liquid crystal cell C1, is subsequently refracted in the second liquid crystal cell C2 and bends to the left side of the figure. Thus, display light DL is emitted at position P2 as shown in, for example, FIG. 16.

The right side of the figure shows a case where the first liquid crystal cell C1 is in an off state (OFF), and the second liquid crystal cell C2 is in an on state (ON). In the first liquid crystal layer LC1, the liquid crystal molecules LM1 are aligned in a hybrid alignment manner. In the second liquid crystal layer LC2, the liquid crystal molecules LM2 are substantially uniformly horizontally aligned. Display light DL is refracted in the first liquid crystal cell C1, bends to the right side of the figure and is not substantially refracted in the second liquid crystal cell C2. As a result, display light DL which passed through the first liquid crystal cell C1 and the second liquid crystal cell C2 bends to the right side of the figure. Thus, display light DL is emitted at position P1 as shown in, for example, FIG. 15.

In this manner, the emission position of display light DL can be adjusted in the range from position P1 to position P2 by controlling the refractive index distributions of the first liquid crystal layer LC1 and the second liquid crystal layer LC2.

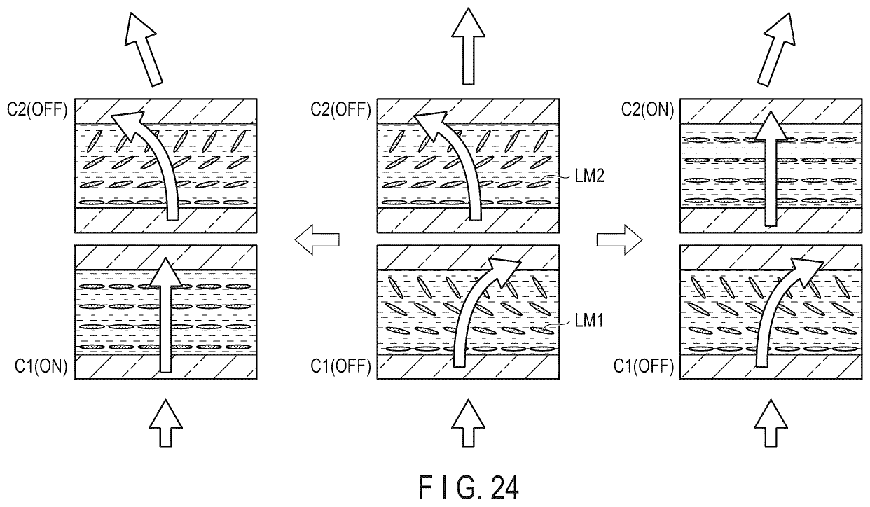

FIG. 24 is a diagram for explaining another relationship between the refractive index distributions of the first liquid crystal cell C1 and second liquid crystal cell C2 shown in FIG. 20 and display light DL.

In the example shown in FIG. 24, each of the first liquid crystal layer LC1 and the second liquid crystal layer LC2 is a negative liquid crystal layer.

The center of the figure shows a case where the first liquid crystal cell C1 and the second liquid crystal cell C2 are in an off state (OFF). In the first liquid crystal layer LC1, the liquid crystal molecules LM1 are aligned in a hybrid alignment manner. In the second liquid crystal layer LC2, the liquid crystal molecules LM2 are aligned in a hybrid alignment manner. Display light DL is refracted in the first liquid crystal cell C1 and bends to the right side. Further, display light DL is refracted in the second liquid crystal cell C2 and bends to the left side. As a result, display light DL which passed through the first liquid crystal cell C1 and the second liquid crystal cell C2 travels in substantially a straight line. Thus, display light DL is emitted at position P0 as shown in, for example, FIG. 14.

The left side of the figure shows a case where the first liquid crystal cell C1 is in an on state (ON), and the second liquid crystal cell C2 is in an off state (OFF). In this case, in a manner similar to that of the example shown on the left side of FIG. 23, display light DL which passed through the first liquid crystal cell C1 and the second liquid crystal cell C2 bends to the left side. Thus, display light DL is emitted at position P2 as shown in, for example, FIG. 16.

The right side of the figure shows a case where the first liquid crystal cell C1 is in an off state (OFF), and the second liquid crystal cell C2 is in an on state (ON). In this case, in a manner similar to that of the example shown on the right side of FIG. 23, display light DL which passed through the first liquid crystal cell C1 and the second liquid crystal cell C2 bends to the right side. Thus, display light DL is emitted at position P1 as shown in, for example, FIG. 15.

In this manner, the emission position of display light DL can be adjusted in the range from position P1 to position P2 by controlling the refractive index distributions of the first liquid crystal layer LC1 and the second liquid crystal layer LC2.

When the optical path adjustment element AD is configured by stacking a plurality of liquid crystal cells, a liquid crystal cell including a negative liquid crystal layer and a liquid crystal cell including a positive liquid crystal layer may be combined.

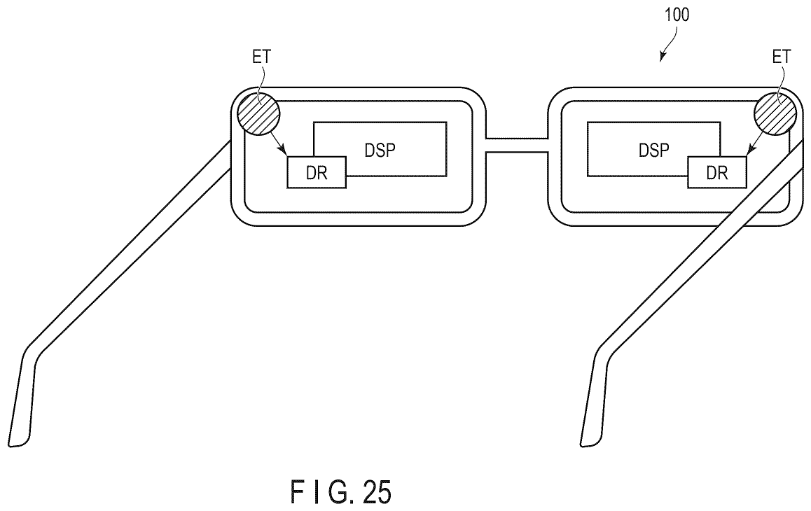

FIG. 25 is a diagram for explaining an application example of the display device DSP.

FIG. 25 shows an eyeglasses-type head-mounted display 100. The head-mounted display 100 comprises the display device DSP at positions corresponding to the right and left eyes of the user, respectively, and comprises eye tracking mechanisms ET which track the positions of the right and left eyes. Each eye tracking mechanism ET is configured to output a signal corresponding to the position of the eye to the driver DR. The driver DR drives at least one of the first liquid crystal cell C1 and the second liquid crystal cell C2 as described above. The driver DR controls the application voltage of the first transparent electrode, the second transparent electrode, the third transparent electrode and the fourth transparent electrode described above, and controls the refractive index distribution of the first liquid crystal layer LC1 and the refractive index distribution of the second liquid crystal layer LC2. By this configuration, images can be displayed so as to correspond to the positions of the eyes of the user.

As explained above, the embodiment can provide a display device and a light guide element such that the reduction in the visibility of images can be prevented.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a transparent substrate having a first main surface and a second main surface which faces the first main surface;
a display element configured to emit display light toward the transparent substrate;
an optical path adjustment element provided on the second main surface which faces the display element;
a first optical element which overlaps the optical path adjustment element and diffracts display light which passed through the transparent substrate and the optical path adjustment element so as to be totally reflected inside the transparent substrate; and
a second optical element which is provided on the second main surface and diffracts display light which propagated inside the transparent substrate so as to be emitted from the first main surface, wherein
the optical path adjustment element is configured to adjust an optical path of display light to change an emission position of display light.

2. The display device of claim 1, wherein
the optical path adjustment element comprises:
an elastic layer provided between the transparent substrate and the first optical element; and
a variable mechanism for making a thickness of the elastic layer variable.

3. The display device of claim 2, wherein
the elastic layer is formed of a transparent resin.

4. The display device of claim 2, wherein
the elastic layer is formed of a transparent liquid.

5. A display device comprising:
a transparent substrate having a first main surface and a second main surface which faces the first main surface;
a display element configured to emit display light toward the transparent substrate;
an optical path adjustment element provided on the first main surface between the transparent substrate and the display element;
a first optical element which is provided on the second main surface facing the optical path adjustment element and diffracts display light which passed through the transparent substrate so as to be totally reflected inside the transparent substrate; and
a second optical element which is provided on the second main surface and diffracts display light which propagated inside the transparent substrate so as to be emitted from the first main surface, wherein
the optical path adjustment element is configured to adjust an optical path of display light to change an emission position of display light.

6. The display device of claim 5, wherein
the optical path adjustment element comprises at least one liquid crystal cell.

7. The display device of claim 6, wherein
the optical adjustment element comprises, as a first liquid crystal cell:
a first substrate comprising a first transparent electrode and a first horizontal alignment film which covers the first transparent electrode;
a second substrate comprising a second transparent electrode and a first perpendicular alignment film which covers the second transparent electrode; and
a first liquid crystal layer which is held between the first substrate and the second substrate and contains liquid crystal molecules which are aligned in a hybrid alignment manner in a state where no voltage is applied to the first transparent electrode and the second transparent electrode.

8. The display device of claim 7, wherein
the optical path adjustment element further comprises, as a second liquid crystal cell which overlaps the first liquid crystal cell:
a third substrate comprising a third transparent electrode and a second horizontal alignment film which covers the third transparent electrode;
a fourth substrate comprising a fourth transparent electrode and a second perpendicular alignment film which covers the fourth transparent electrode; and
a second liquid crystal layer which is held between the third substrate and the fourth substrate and contains liquid crystal molecules which are aligned in a hybrid alignment manner in a state where no voltage is applied to the third transparent electrode and the fourth transparent electrode.

9. The display device of claim 8, wherein
an alignment treatment direction of the first horizontal alignment film and an alignment treatment direction of the second horizontal alignment film are parallel to each other and are opposite directions.

10. A light guide element comprising:
a transparent substrate having a first main surface and a second main surface which faces the first main surface;
an optical path adjustment element provided on the second main surface;
a first optical element which overlaps the optical path adjustment element and diffracts light which passed through the transparent substrate and the optical path adjustment element so as to be totally reflected inside the transparent substrate; and
a second optical element which is provided on the second main surface and diffracts light which propagated inside the transparent substrate so as to be emitted from the first main surface, wherein
the optical path adjustment element is configured to adjust an optical path of incident light to change an emission position of light.

11. The light guide element of claim 10, wherein the optical path adjustment element comprises:
an elastic layer provided between the transparent substrate and the first optical element; and
a variable mechanism for making a thickness of the elastic layer variable.

12. The light guide element of claim 11, wherein
the elastic layer is formed of a transparent resin.

13. The light guide element of claim 11, wherein
the elastic layer is formed of a transparent liquid.

14. A light guide element comprising:
a transparent substrate having a first main surface and a second main surface which faces the first main surface;
an optical path adjustment element provided on the first main surface;
a first optical element which is provided on the second main surface facing the optical path adjustment element and diffracts light which passed through the transparent substrate so as to be totally reflected inside the transparent substrate; and
a second optical element which is provided on the second main surface and diffracts light which propagated inside the transparent substrate so as to be emitted from the first main surface, wherein
the optical path adjustment element is configured to adjust an optical path of incident light to change an emission position of light.

15. The light guide element of claim 14, wherein
the optical path adjustment element comprises at least one liquid crystal cell.

16. The light guide element of claim 15, wherein
the optical path adjustment element comprises, as a first liquid crystal cell:
a first substrate comprising a first transparent electrode and a first horizontal alignment film which covers the first transparent electrode;
a second substrate comprising a second transparent electrode and a first perpendicular alignment film which covers the second transparent electrode; and
a first liquid crystal layer which is held between the first substrate and the second substrate and contains liquid crystal molecules which are aligned in a hybrid alignment manner in a state where no voltage is applied to the first transparent electrode and the second transparent electrode.

17. The light guide element of claim 16, wherein
the optical path adjustment electrode further comprises, as a second liquid crystal cell which overlaps the first liquid crystal cell:
a third substrate comprising a third transparent electrode and a second horizontal alignment film which covers the third transparent electrode;
a fourth substrate comprising a fourth transparent electrode and a second perpendicular alignment film which covers the fourth transparent electrode; and
a second liquid crystal layer which is held between the third substrate and the fourth substrate and contains liquid crystal molecules which are aligned in a hybrid alignment manner in a state where no voltage is applied to the third transparent electrode and the fourth transparent electrode.

18. The light guide element of claim 17, wherein
an alignment treatment direction of the first horizontal alignment film and an alignment treatment direction of the second horizontal alignment film are parallel to each other and are opposite directions.
